(19) United States
(12) Patent Application Publication
(10) Pub. No.: US 2020/0291303 A1
(43) Pub. Date: Sep. 17, 2020

(54) METHOD AND CATALYST FOR PRODUCING HIGH OCTANE COMPONENTS

(71) Applicant: LLC "NGT-synthesis", Moscow (RU)

(72) Inventors: Vladimir Vladislavovich IMSHENETSKIY, Moscow (RU); losif Izrailevich LISHCHINER, Moscow (RU); Olga Vasilyevna Malova, Moscow (RU); Denis Vasilyevich PCHELINTSEV, Moscow (RU); Andrey Leonidovich TARASOV, Moscow (RU)

(73) Assignee: LLC "NGT-synthesis", Moscow (RU)

(21) Appl. No.: 16/081,947

(22) PCT Filed: Mar. 9, 2016
(86) PCT No.: PCT/RU2016/000128

§ 371 Date: Sep. 3, 2018

(51) Int. Cl. C10G 11/05; C10G 35/06; B01J 37/00; B01J 29/46; B01J 38/16

(52) U.S. Cl. CPC C10G 11/05; C10G 35/065; B01J 37/0009; B01J 29/46; C10G 2300/202; C10G 2300/305; C10G 2400/30; C10G 2300/4006; C10G 2300/4012; B01J 38/16

(57) ABSTRACT

The group of inventions relates to a process of co-converting hydrocarbon feedstock with a high content of unsaturated hydrocarbons and aliphatic alcohols into components of high octane gasolines or aromatic hydrocarbons, as well as to catalysts of such a co-conversion. The method of co-converting hydrocarbon fractions and oxygenates into high octane components of fuels or aromatic hydrocarbons including contacting a hydrocarbon stream mixed with oxygenates with a catalyst under a reduced pressure and with heating. The process is carried under using a catalyst that contains the HZSM-5 zeolite that passed thermal and steam treatment.

### FIELD OF THE INVENTION

The group of inventions relates to the refining and petrochemical industry, and in particular, to a technology of co-converting hydrocarbon feedstock with a high content of unsaturated hydrocarbons (pyrolysis/oligomer gasolines, etc.) and aliphatic alcohols (methanol, ethanol) and/or their ethers into components of high octane gasolines or aromatic hydrocarbons (AHC), as well as to catalysts of such a co-conversion.

### PRIOR ART

The Russian patent No. 2147598, C10G29/04, publ. 20 Apr. 2000, by Ufa State Oil Technical University, provides a method for removal of unsaturated resinifying components from pyrolysis gasolines based on their catalytic conversion using an aluminosilicate catalyst into high-boiling oligomers with their subsequent separation from the product mixture by means of fractionation, when gasoline vapors are subject to purification through their contact in the reaction device with subsequent separation from them of oligomers formed in the separation zone. A disadvantage of the method is a complicated design of the reaction apparatus that provides simultaneously the conversion of unsaturated compounds and the separation of oligomers from distillates to be purified.

The method of isolation of widely sought aromatic hydrocarbons, i.e. benzene, toluene, meta-, para- and orthoxylene from pyrolysis gasolines, which is seen as the only possible at the moment, is a complex extractive distillation method. However, the presence in pyrolysis gasoline of unsaturated and saturated hydrocarbons boiling in the boiling range of 90−154° C. makes impossible efficient extractive isolation of pure products for their further use, e.g. as solvents. In addition, in terms of recovery of styrene from pyrolysis gasolines (polymerizable monomer in demand), it should be noted that phenylacetylene (PA) and styrene that are necessarily present in pyrolysis gasoline exhibit similar interaction with extraction-distillation solvent, as their molecules are similar in their chemical structure. Therefore, it is impossible to achieve effective separation of styrene from PA using the extraction distillation.

There are techniques of refinement—removal of resinifying components, such as dienes, trienes, and aromatic olefins, from pyrolysis gasolines. The application for the Russian Patent No. 2011153741, C10G45/02, publ. 20 Jul. 2013, by SHELL INTERNATIONALE RESEARCH MAATSCHAPPIJ BV (NL), describes a method based on the selective hydrogenation of pyrolysis gasolines. At the first stage, diolefins are removed during the hydrogenation at lower temperatures on highly active catalysts in the so-called process of selective hydrogenation. After selective hydrogenation of diolefins, other impurities, i.e. olefins, sulphur-containing and oxygen-containing elements are removed at higher temperatures (240-320° C.) in the gas phase at deep hydrogenation stages using a nickel-molybdenum catalyst, in a pre-reactor and on a cobalt-molybdenum catalyst in a main reactor (analogue of BASF-Scholven process). A disadvantage of the method is that it is actually a three-step process. The disadvantage of these methods of hydrogenation of pyrolysis gasolines is their high cost due to the use of expensive catalysts containing precious metal, a high hydrogen circulation at liquid-phase hydrogenation step, which results in increased energy consumption for the circulation of hydrogen and high pressures (50-100 bar) of the process at the liquid-phase hydrogenation step.

Therefore, finding alternative less expensive ways of refining gasolines, including pyrolysis gasolines, is relevant. One of the ways of converting low-grade pyrolysis gasolines and low-octane straight-run gasoline into high octane gasoline components or aromatic hydrocarbons (AHC) is co-processing of hydrocarbon feedstock with oxygenates. Recently, a large number of inventions have appeared describing various ways of co-processing hydrocarbon fractions and oxygenates, as well as catalysts for this process.

For example, in the Russian Patent No. 2163623, C10G35/095, publ. 27 Feb. 2001, by S. I. Kolesnikov, low-octane straight-run gasoline fraction is reformed in the presence of mono- or dihydric alcohol taken in an amount of 0.2-5.0 wt. %. The catalyst for the process is a mechanical mixture of the two catalysts—zeolite-containing catalyst and aluminum-cobalt (nickel) molybdenum oxide catalyst. The process is carried out at 460-510° C. and at a feedstock volumetric flow rate of 0.3-0.9 hr⁻¹. The advantage of this method is the possibility of a substantial (by 10-15 points) increase in the octane number of straight-run gasolines due to the formation of an additional amount of aromatic hydrocarbons, but the disadvantage of this method is the high sensitivity of the oxide catalyst to the sulfur-containing impurities, and low resistance of zeolite catalyst to water vapor, which forms during the conversion of oxygenates.

The Russian Patent No. 2189858, B01J29/40, C07C1/20, publ. 27 Sep. 2002, by New Catalytic Technology CJSC et al., describes a catalyst for the production of liquid hydrocarbons from low molecular weight oxygenates including crystalline pentasil-type aluminosilicate with a molar ratio of silica to alumina of 25 to 120, sodium oxide, zinc oxide, oxides of rare earth elements and a binder, wherein to each value of the ratio of silica to alumina in the crystalline pentasil type aluminosilicate corresponds a specific range of sodium oxide values, at which a high degree of conversion of the oxygenates of no less than 90% is provided.

The disadvantage of the catalyst is its low resistance to water vapor formed during the co-conversion of hydrocarbon feedstock and oxygenates leading to a rapid loss of strength properties of the catalyst. In addition, a disadvantage of this catalyst is the rapid decline of its activity and, as a consequence, the need for frequent oxidative regenerations of the catalyst.

The Russian Patent No. 2440189, B01J29/40, C07C1/20, publ. 20 Feb. 2012, by GTL (RU) Open Joint Stock Company, describes a method for producing a high octane aromatic fraction of aromatic hydrocarbons with an aromatic content of up to 50% by weight. The process is carried out in an isothermal reactor fitted with heat pipes and at a temperature of 280-320° C., a pressure of 0.1-1 MPa with raw material fed into the reactor at a volumetric feed rate of 1-5 h⁻¹ (in terms of liquid) and inert gas (1000-10000 h⁻¹). The catalyst is a mechanical mixture of pentasil type zeolite having a silicate modulus of SiO₂/Al₂O₃=18-25, containing no modifier, pretreated with an aqueous alkali solution, and a pentasil type zeolite having a silicate modulus of SiO₂/Al₂O₃=70-90 modified with magnesium oxide in an amount of 0.5-3.0 wt. %, taken in a ratio of 1/1 to 1/10 and a binder in an amount of 20 to 25 wt. % of the catalyst.

A significant disadvantage of the method is that the subsequent recovery of individual aromatic hydrocarbons (benzene, toluene, xylenes) from the high octane aromatic fraction of aromatic hydrocarbons requires a rather complicated extractive distillation, since the composition of the high octane aromatic fraction of aromatic hydrocarbons contains aliphatic and residual unsaturated hydrocarbons. Furthermore, the product produced contains 3.7 to 4.3% by weight of durene having a high melting point of approx. 80° C. and being prone to crystallization.

A close analogue by the catalyst composition is a catalyst for the production of liquid hydrocarbons from dimethyl ether described in the Russian Patent No. 2160161, B01J29/46, C07C1/20, publ. 10 Dec. 2000, by New Catalyst Technology CJSC. The catalyst comprises a crystalline pentasil-type aluminosilicate having a molar ratio of SiO₂/Al₂O₃=25-100, and a residual amount of sodium ions being equivalent to the content of 0.05-0.1 wt. % of sodium oxide in it in an amount of 65-70 wt. %, zinc oxide in an amount of 0.5-3.0 wt. %, oxides of rare earth elements (REE) in an amount of 0.1-5.0 wt. %, cobalt oxide in an amount of 0.05-2.5 wt. % and a binder being the rest. Its version contains 0.5-3.0 wt. % of zinc oxide, 0.1-5.0 wt. % of oxides of rare earth elements, 0.1-0.3 wt. % of copper chromite, 65-70 wt. % of said aluminosilicate, and a binder being the rest.

The disadvantage of the catalyst is its low resistance to water vapor formed during the co-conversion of aromatic hydrocarbon raw material and oxygenates leading to a rapid loss of strength properties of the catalyst. Also, a disadvantage of this catalyst is the rapid decline of its activity and, as a consequence, the need for frequent oxidative regenerations of the catalyst.

The closest to the present group of inventions is the patent of the Russian Federation No. 2544017, B01J29/40, C01C1/20, publ. 10 Mar. 2015, by O. V. Malova et al., which discloses a process for the aromatization of C₃-C₄ gases, low-octane hydrocarbon fractions and aliphatic alcohols, as well as mixtures thereof, including the step of contacting the heated feed gas with a zeolite catalyst at elevated pressure and temperature; the process is carried out in an isothermal reactor at a catalyst temperature of 400-500° C. in the pressure range of 1-18 bar while a fixed bed catalyst is contacting with feedstock gas vaporized and heated in a preheater to a temperature of 150-250° C. at a volumetric flow rate of 300-1500 hr⁻¹. Example No. 8 of a known patent describes an example of converting the olefin-containing gas fraction, in particular, propane-propylene and butane-butylene mixture fraction containing 60.2% by weight of olefins, and isopropanol, wherein at T=450° C. and P=6 bar, the gasoline yield of the hydrocarbon portion of raw material is 78.2%, while the concentration of the aromatic hydrocarbons in the gasoline is 91.2%. The catalyst of the proposed method comprises a mechanical mixture of two pentasil type zeolites having a silica modulus (SiO₂/Al₂O₃) of 20 and 82, which is modified with oxides of rare earth elements in an amount of 0.5 to 2.0 wt. % (for the first zeolite) and magnesium oxide in an amount of 0.5 to 5.0 wt. % (for the second zeolite) and contains 0.04 wt. % of residual amounts of sodium oxide, wherein zeolites are taken in a weight ratio of 1.7/1 to 2.8/1, and a binder (20-25 wt. %) comprises a mixture of alumina and silica.

A disadvantage of the method is a high process temperature (up to 500° C.), which leads to increased formation of C₁-C₂ hydrocarbon fractions, as well as the inability to use as raw material the hydrocarbon fractions with high content of unsaturated compounds such as dienes, styrene, etc., for example, butane-butylene fraction containing butadienes, since the catalyst composition contains strongly acidic low modulus zeolite (SiO₂/Al₂O₃=20) that promotes intense oligomerization of dienes to form high molecular weight oligomers which lead to rapid deactivation of the catalyst.

### SUMMARY OF THE INVENTION

The overall object of the group of inventions and the required technical result achieved by using the group of inventions is to provide a new and effective method of refining (reforming) of various hydrocarbon fractions, including pyrolysis ones, oligomer-gasolines and catalytic cracking gasolines and mixtures thereof with gasoline fractions of various origin, for example, straight-run gasoline, in which, at a high yield of 89-120% to the original gasoline, a fraction of aromatic hydrocarbons is produced with a higher content of C₇-C₈ aromatic hydrocarbons, which can be used directly as a high octane additive for motor fuels, as well as for producing individual aromatic hydrocarbons (benzene, toluene, xylenes and trimethylbenzenes) by simple distillation that is less costly than extractive distillation.

The overall object of the group of inventions and the required technical result to be achieved by using the group of inventions is also to create a new composition of the catalyst, working at high temperatures and resistant to water vapor action, and at the same time providing an increased long-term stability of the catalyst (cycle length) when working on such inconvenient feedstock as pyrolysis gasolines, oligomer-gasolines and catalytically cracked gasolines containing high concentrations of resinifying unsaturated hydrocarbons, as well as mixtures thereof with various hydrocarbon fractions.

The object and the required technical result when using the group of inventions are achieved by that according to the method of co-converting hydrocarbon fractions and oxygenates into high octane components of fuels or aromatic hydrocarbons including contacting a hydrocarbon stream mixed with oxygenates with a catalyst under a reduced pressure and with heating, according to the invention, the process is carried out under conditions of maximum conversion of feedstock unsaturated hydrocarbons into aromatic hydrocarbons using a catalyst that contains the HZSM-5 zeolite that passed thermal and steam treatment, wherein the hydrocarbon feedstock is a mixture of hydrocarbon fractions, including those containing up to 85 wt. % of olefins, and oxygenates used in pure form or as mixtures thereof with water in a volume ratio of water to oxygenates equal to 1:2-10, wherein the method is carried out at a pressure of 1-50 bar, preferably at 3 bar, at temperatures of 290-460° C., preferably at temperatures of 365-420° C., in a mixture with a volume ratio of hydrocarbon fraction to oxygenate aqueous solution equal to 1:0.1-1 at a mass feed rate of the mixture equal to 0.5-4 h⁻¹, and the pyrolysis gasolines and oligomer gasolines, light fractions of catalytic cracking gasolines having a final boiling point of up to 150° C., and straight-run hydrocarbon fractions, containing components with boiling points in the range boiling point 25-200° C., fraction containing olefins C₂-C₁₄ family, are used as the hydrocarbon feedstock, whereas a mixture of pentasil group zeolites having various silicate moduluses, namely, the zeolite having SiO₂/Al₂O₃=15-30, previously treated with an aqueous alkaline solution and modified with oxides of rare earth elements (REE) in an amount of 0.5-2.0 wt. %, and the zeolite having SiO₂/Al₂O₃=50-85 with a residual amount of sodium oxide of 0.04-0.15 wt. % taken in a ratio of 1.7/1 to 2.8/1, is used as the HZSM-5 zeolite, wherein together with the hydrocarbon feedstock the water is supplied at a volume ratio of water:hydrocarbon=1:10-50.

The object and technical result required when using the group of the inventions are also achieved by that the catalyst for carrying out the method of co-converting hydrocarbon fractions and oxygenates into high octane components of fuels or aromatic hydrocarbons using the proposed method consists of the HZSM-5 zeolite having a silicate modulus of SiO₂/Al₂O₃=50-81.9 with a residual amount of sodium oxide of 0.04-0.15 wt. % that passed thermal and steam treatment before the catalyst preparation step, in an amount of 65-69.8 wt. %, zinc oxide in an amount of 1.5-2 wt. %, oxides of rare earth elements in an amount of 1-2 wt. %, oxides and/or sulfides of Group VIII metals in an amount of 0.5-1 wt. %, a binder being balance to 100,%, wherein the binder is a mixture of alumina in an amount of 30.1-69.9% by weight and silicon oxide in an amount of 69.9-30.1% by weight.

### BRIEF DESCRIPTION OF THE DRAWINGS

FIG. 1 presents data of the derivatographic study of samples of catalysts from Example No. 1 (A) and No. 4 (B) after operation for 82 and 56 hours.

### EMBODIMENT OF THE INVENTION

The catalyst is prepared as follows. The pentasil type zeolite (HZSM-5 with a silica modulus of SiO₂/Al₂O₃=70-81.9 with a residual amount of sodium oxide of 0.04-0.15 wt. %) in the form of a powder is preliminarily subjected to dealumination by means of its thermal and steam treatment in a stream of moist air having a water vapor partial pressure of 10-60 kPa at a temperature of 500-550° C., and then the produced zeolite and binder are mixed by any means such as stirring, kneading or otherwise. The binder is a mechanical mixture of pseudoboehmite and silica glass that during the final calcination forms a mixture of aluminum oxide (30.1-69.9% wt.) and silicon oxide (69.9-30.1 wt. %). Further, the zeolite-binder mixture is extruded to form granules, the granules are dried in air at 90° C. and calcined at 450-500° C. for 2-4 hours. The produced catalyst substrate is subjected to modification with metals of Group II and III during simultaneous impregnation of granules based on moisture capacity from an aqueous solution of zinc nitrate and a mixture of rare earth elements (REE). The proposed method uses a REE concentrate having the following composition: lanthanum nitrate (50-60%), cerium (8-10%), praseodymium (1-2%) and neodymium (the rest). Additionally, the catalyst is admixed with oxides and/or sulfides of Group VIII metals, preferably those of nickel. After these operations, the finished catalyst is subjected to final calcination in air at 550° C. for 2-4 hours.

It has been observed that when alumina is used as a binder, during the catalyst operation it is converted to hydroxide and the catalyst loses its strength properties, but when silicon oxide is used, the pores in the matrix are small enough for the reactants to access the active sites of the HZSM-5 zeolite. Whereas, when used together, the binder features the formation of the required pores and its mechanical properties increase after the thermal and steam treatment. At the same time, cheap and readily available components are used, compared, for example, with zirconium oxide. A similar effect was observed with respect to zeolite, namely, that its thermal and steam treatment should be carried out before it is mixed with the components of which the binder is formed during thermal treatment. With the thermal and steam treatment, the acid (Lewis and Broensted) active sites required for the reaction are formed in zeolite. Precisely because of this, and because the initial components of the binder are a mixture of sodium silicate and aluminum oxide, a composite product is produced that can be operated for a long time in the environment of superheated steam, while the catalytic properties of zeolite are preserved and a mesoporous structure (transport channels for reactant access to the active sites of the HZSM-5 zeolite) is formed in this composite material. After regeneration of the catalyst with a mixture of nitrogen and oxygen after the first 200 hours of operation cycle length of the catalyst in an environment containing superheated steam or after additional thermal and steam treatment at a temperature of 600 C, obtained by the described above method of catalyst an increase in the strength properties of the catalyst was observed. Since the mechanical crush strength of the catalyst granules increased from 5.5 MPa to 8.7 MPa, without changing its other performance properties (change of gasoline yield with increased knock characteristic while maintaining of selectivity on alkylaromatics, duration of cycle length).

It should be noted that when alumina in an amount of less than 30.1% by weight is used in the binder, the combination of acidity properties of the HZSM-5 zeolite used in the catalyst and alumina as a single active component of the catalyst, required in order to obtain a high quality product (co-processing gasoline) with the desired aromatic hydrocarbon content, is not ensured.

When using alumina in the binder in an amount of more than 69.9% by weight, during the catalyst operation the catalyst loses its strength properties due to the partial conversion of the alumina to aluminum hydroxide.

It should also be noted that when silica is used in the binder in an amount of less than 30.1% by weight, the required catalyst pellet strength is not reached.

When silicon oxide is used in an amount of more than 69.9% by weight, the required pores (transport channels) are not formed in the binder in an amount sufficient for the reactants to access the active sites of zeolite HZSM-5.

It should also be noted that when the HZSM-5 zeolite is used having a silicate modulus of SiO₂/Al₂O₃=70-81.9 subjected to the thermal and steam treatment before the stage of catalyst preparation in an amount of less than 65.0 wt. %, the catalyst activity decreases. When the said zeolite is used in an amount of more than 69.8% by weight, the required pellet strength of the catalyst operating at high temperature in the presence of steam is not reached.

A distinctive feature of the catalyst is that during its preparation, the HZSM-5 zeolite determining the catalytic properties of the finished catalyst has already been subjected to the thermal and steam treatment, which considerably increases its resistance to water vapor and, in addition, a combination of silica and alumina is used as a binder, which confers additional stability to the catalyst (including increased mechanical strength) in the high temperature conversion process in the presence of water addition to raw materials. In addition, a feature of the catalyst is that the zeolite catalyst acidity controlled by the addition of zinc and rare earth oxides allows simultaneously conducting aromatization reactions of C₅-C₁₀ unsaturated hydrocarbons, and the alkylation reactions of lowest aromatics (e.g. benzene, toluene) with methyl fragments of methanol and/or with ethylene and propylene formed (in situ) during the conversion of methanol, which results in production of aromatic hydrocarbon fractions with a high content of C₈ aromatic, which can then be used in organic syntheses.

The choice of catalyst that contains only a high modulus medium acidity zeolite (SiO₂/Al₂O₃=70-81.9), as well as the choice of a low-pressure process, allow reducing the intensity of the oligomerization of C₆-C₁₀ olefins that are present in large quantities in the pyrolysis and oligomer gasolines, while increasing the aromatization contribution of these components to the produced product. It is generally known that it is C₁₂-C₂₀ (or higher) high molecular weight oligomers that are precursors of coke.

The combination of all the above catalyst features enables to solve the specified technical problem and to achieve the desired technical result.

The proposed method may use, as the hydrocarbon fractions, pyrolysis gasolines with high content of aromatic and unsaturated compounds, olefin-containing fractions of low octane gasolines, including oligomer gasolines, light fractions of catalytic cracking gasolines (with a final boiling point up to 150° C.), and straight-run hydrocarbon fractions, refined products from extractive distillation processes of aromatic hydrocarbons, C₅-C₆ fractions of reforming gasolines, and mixtures thereof.

The method of co-converting hydrocarbon fractions and oxygenates is carried out at a pressure of 1-5 bar, preferably 3 bar, and at temperatures of 365-460° C. The proposed method is characterized in that the process is carried out using a catalyst that contains the HZSM-5 zeolite that has passed thermal and steam treatment, and that oxygenates, preferably methanol or ethanol diluted with water, are used as part of the raw materials, which finally results in an increase in the yield and/or aromatic hydrocarbon concentrations in liquid products, as well as in the decrease in the coke formation and, consequently, in the increase in the catalyst cycle length when running on olefin hydrocarbon feedstock.

In more detail, the proposed group of inventions is described by the following examples, which are for illustration only and are not restrictive.

### Example 1

The process is carried out in a flow isothermal reactor heated by a peripheral heat pipe while contacting 100 cm³ of catalyst (the bed height is 25 cm) heated to 420° C. with feedstock consisting of 2 streams: pyrolysis gasoline (from Ufa Refinery) and 70% methanol solution in water, which are mixed in a mixer that is a precontact zone (quartz beads placed in the reactor upstream the frontal catalyst bed). The flow rate of the pyrolysis gasoline and aqueous solution of methanol was 50 and 65 ml/h, respectively. The methanol conversion was 100% at the initial time point after start-up (the first 6 hours). The experiment was carried out until reduction in methanol conversion from 100 to 95% was observed. The liquid catalysate produced during the experiment was cooled down to 18° C. and was separated into a hydrocarbon (gasoline) and an aqueous phase, stabilization gases upon completion of the experiment.

The hydrocarbon fraction was weathered at room temperature for 30 minutes and analyzed using the Crystallux chromatograph while using the SE-30 (30 m) capillary column and FID detector. The methanol content in the aqueous phase was determined by chromatography using the Heyesep-Q (m 3) packed column and TCD detector.

### Example 2

The process was performed as in Example No. 1, except for using the oligomer gasoline (produced by Orlen Lietuva) and a 50% solution of ethanol in water. The flow rate of oligomer gasoline and ethanol solution in water was 120 and 30 ml/h, respectively.

### Example 3

The process was performed as in Example No. 1, except for using a mixed fraction consisting of 50% vol. of light fraction catalytic cracking gasoline (from Ufa Refinery) having an initial boiling point of 110° C., and the rest was the fraction of gas condensate having a final boiling point of 150° C. and 90% methanol in water. The flow rate of the straight-run gasoline fraction and methanol solution in water was 100 and 40 ml/h, respectively. The said mixed fraction contained up to 0.3-0.5% by weight of C₅+ diene and triene hydrocarbons. The life experiment was conducted for a long time (440 hours). The process temperature during the experiment was increased by 5° C. when the conversion of methanol reduced to 95%.

### Example 4

The process was performed as in Example No. 1, except for using as a raw material butane-butylene fraction (BBF) contained butenes 83% by weight, which includes butadienes 0.3% by weight. Feed BBF fraction and 98% solution of methanol in water was 30 and 330 ml/h, respectively.

### Example 5

The process was performed as in Example No. 1, except that instead of 65 ml/hr of 70% methanol solution in water, the A.s. pure grade methanol at a flow rate of 50 ml/hr was taken.

The catalyst used in Examples Nos. 1-4 had the following composition (wt. %):
HZSM-5 zeolite having a silicate modulus of SiO₂/Al₂O₃=81.9 with a residual amount of sodium oxide of 0.04 wt. % subjected to the thermal and steam treatment before the catalyst preparation step: 69.8 wt. %.
Zinc oxide: 2 wt. %.
REE oxides: 1.5 wt. %.
Nickel oxide: 0.5 wt. %.
Binder (mixture of alumina: 50 wt. % and silicon oxide: 50 wt. %), the rest up to 100%.

The process conditions and composition of the main components of hydrocarbon feedstock and liquid product obtained using the present process (Examples Nos. 1-3), and through the comparative Example (No. 4) are specified in Table 1.

TABLE 1

| | | | | Mixed | | | | | |
|---|---|---|---|---|---|---|---|---|---|
| | | | | fraction | | | | | |
| | | | | consisting | | | | | |
| | | | | of a mixture | | | | | |
| | | | | of light | | | | | |
| | | | | fraction of | | | | | |
| | | | | catalytic | | | | | |
| | | | | cracking | | | | | |
| | | | | gasoline, 50% | | | | | |
| | | | | vol., and the | | | | | |
| | | Pyrolysis | Oligomer | rest is light | Example | Example | Example | Example | Example |
| | BBF | gasoline | gasoline | gas condensate. | No. 1 | No. 2 | No. 3 | No. 4 | No. 5 |
| Temperature, ° C. | | | | | 420-450 | 380 | 365-390 | 290-330 | 420-460 |
| Pressure, bar | | | | | 5 | 1 | 3 | 20 | 5 |
| | Components of the hydrocarbon fraction, % wt. | | | | | | | | |
| The total content | 0 | 87.2 | 8.1 | 3.75 | 89 | 70.1 | 68.4 | 15.8 | 90 |
| of aromatic | | | | | | | | | |
| hydrocarbons, | | | | | | | | | |
| which includes: | | | | | | | | | |
| Benzene (C6) | — | 36.51 | 3.3 | 0.45 | 13.3 | 8.2 | 2.7 | 0.2 | 13.3 |
| Toluene (C7) | — | 18.86 | 2.1 | 3.17 | 24.5 | 23.7 | 16.7 | 0.5 | 24.5 |
| Ethylbenzene + | — | 4.65 | 1.9 | 0.13 | 28.3 | 26.6 | 27.9 | 2.4 | 28.2 |
| xylenes (C8) | | | | | | | | | |
| Olefins C5-C9 | 0 | 7.2 | 0.5 | — | 11.4.8 | 11.6 | 21.0 | 20 | 0.3 |
| Iso- and n- | 0 | 7 | 56.1 | 83.96 | 4.4 | 14.2 | 30.8 | 64.2 | 5.7 |
| paraffins, | | | | | | | | | |
| naphthenes | | | | | | | | | |
| C5-C8 | | | | | | | | | |
| n-butane | 1 | — | — | — | — | — | — | — | — |
| | 2 | | | | | | | | |
| Isobutane | 4. | — | — | — | — | — | — | — | — |
| | 5 | | | | | | | | |
| Olefines C4 | 8 | | | | | | | | |
| | 3 | | | | | | | | |
| | Indicators | | | | | | | | |
| Yield of gasoline | — | — | — | — | 120 | 108.9 | 89.1 | 89.6 | 120.2 |
| to the original | | | | | | | | | |
| gasoline, % | | | | | | | | | |
| Stability of | — | — | — | — | 82 | 70 | 110/400** | 120 | 56 |
| catalyst | | | | | | | | | |
| operation, | | | | | | | | | |
| hour* | | | | | | | | | |

*—Stability was evaluated by the time of the catalytic work until the decrease in the conversion of oxygenates from 100 to 98%.
**Time was fixed at the moment of the temperature rise at the end of the catalyst layer from 385 to 390° C.

Table 1 shows that in case of the embodiment of the method by Example No. 1, the concentration of styrene reduces significantly (by more than 10 times) (down to 0.15%) in the resulting fraction of aromatic hydrocarbons, however, unsaturated compounds such as dienes, trienes, and indene were not detected in the resultant fractions.

The yield of the produced liquid product and aromatic hydrocarbon content therein is significantly higher (120.0% and 95.1, respectively) than that in the prior art for the conversion of olefins from a mixture of 50/50 PPF and BBF (78.2 and 91.8%, respectively).

In addition, Table 1 shows that in case of the embodiment of the proposed method by Example No. 2, during conversion of oligomer gasoline containing up to 40% olefins, but different in chemical composition from pyrolysis gasoline, a yield of liquid product (108.9%) higher than that in the prior art is reached as well. As the temperature rises, the aromatic content will increase to 80% only, as the yield of liquid hydrocarbons decreases.

In addition, Table 1 shows that in case of the embodiment of the proposed method by Example No. 3, during the conversion of gasoline mixture, a higher yield of liquid product (89.1%) than that in the prior art is reached as well.

Table 1 also shows that in case of the embodiment of the proposed method by Example No 4 g during butylene fraction, a higher yield of liquid product (89.6%) than that in the prior art is reached as well, with a low content of aromatics and olefins, which allows to use the product as a high octane gasoline component with a reduced content of aromatics and olefins. The octane number by research method for the resulting liquid product is 95.6 units.

Lifetime tests of Example No. 3 at an initial temperature of 365° C. show that the catalyst can operate efficiently for 440 hours while ensuring 100% methanol conversion and higher yield of gasoline produced with a higher content of aromatic hydrocarbons (in terms of an initial gasoline yield of about 102%), wherein the temperature of the process is moderate and is no more than 390° C. It should be noted that when the process temperature is increased up to 420° C. and the pressure is reduced from 3 bar down to the atmospheric pressure, the aromatic hydrocarbon content can be increased up to 80%, while the yield of liquid products is no less than 89% of the initial hydrocarbon fraction.

In addition, the concentration of iso-, n-paraffins, C₆-C₈ naphthenes, and olefins is substantially (by several times) decreased in gasolines formed in Examples Nos. 1 and 5 (see Table. 1). This further facilitates isolation of individual C₆-C₈ aromatic hydrocarbons and does not require the expensive extractive distillation.

The comparison of pyrolysis gasoline conversion using the proposed method (Example No. 1) and by Example No. 5, wherein pure methanol is used instead of an aqueous methanol solution, shows that in Example No. 1, as compared with Example No. 5, the stable operation time of catalyst is significantly (by 1.5 times) increased, wherein the component composition of the produced product is practically unchanged.

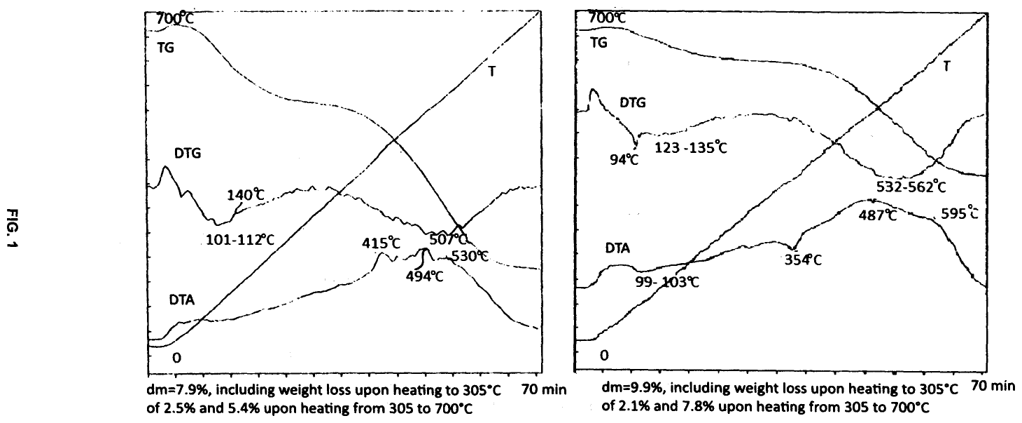

FIG. 1 shows the comparative derivatograms produced by way of thermally programmed burning of coke deposits, catalyst samples of Example No. 1 proposed in the present invention and by Example No. 5. When they are compared, it is evident that the use of water additives to oxygenates (methanol) leads to a substantial reduction in the amount of coke in the catalyst samples (7.9% instead of 9.9%), which ultimately leads to an increase in the stable operation time of catalyst (see Table. 1).

In the proposed method in the present group of inventions, water is both available as part of an aqueous alcohol solution, and formed during the conversion of the latter, in this connection, the positive effect of reducing the coking primarily occurs in the front layer of the catalyst (that assumes the basic chemical conversion of feedstock).

Thus, the aggregate of all of the above catalyst features and method of the co-conversion of hydrocarbon fractions and oxygenates into high octane components of fuel or aromatic hydrocarbons, respectively, allows solving a common technical problem and achieving the desired overall technical result obtained by the embodiment of the proposed group of inventions as follows:
Improving the yield and concentration of aromatic hydrocarbons in liquid products, wherein the subsequent separation of the individual C₆-C₈ aromatics does not require the highly expensive extractive distillation method, because the inventive method allows significantly reducing the concentration of isoparaffins, n-paraffins, olefins, and C₆-C₈ naphthenes boiling in the temperature range of separated aromatic hydrocarbons.
Increasing catalyst cycle length when running on the olefin-containing hydrocarbon feedstock.
Simplifying the process design through the use of lower (including atmospheric) pressure.

Further in the embodiment of the method, instead of using pure alcohols, it becomes possible to use cheaper oxygenates, for example, raw methanol having an alcohol content of up to 85%, and beverage industry waste. It should be noted that in the embodiment of the proposed method, there is a significant reduction in the sulfur content in the resultant fraction of aromatic hydrocarbons (see Table 2), which is also important, because the fraction of aromatic hydrocarbons can then be used as a component of high octane gasolines.

### Table 2. Changes in the Sulfur Content in Products of Pyrolysis Gasoline Conversion Version

TABLE 2
Changes in the sulfur content in products
of pyrolysis gasoline conversion

| | Sulfur content, |
|---|---|
| Product description | wt. % |
| Pyrolysis gasoline | 0.0063 |
| Product of conversion | 0.001 |
| according to Example | |
| No. 1 | |

The above-described group of inventions can be used in the refining and petrochemical industry to produce high octane components of gasoline or their base (the main component) as well as to produce individual aromatic hydrocarbons (benzene, toluene, xylene) isolated during simple distillation and being widely demanded solvents and reagents for production of more complex organic compounds, such as cumene.

The proposed group of inventions can be used for processing of pyrolysis gasolines that constitute the raw material for production of benzene, toluene, xylenes or homologs thereof being valuable in petrochemistry [Orochko, D. I., et al. Hydrogenation processes in oil refining. M.: Chemistry, 1997, 197 pp.], as well as for processing of oligomer gasolines to be obtained by oligomerization of light C₂-C₄ olefins from propylene-propane and butane-butene fractions, gasolines of catalytic dewaxing of middle distillates and mixtures thereof with various hydrocarbon fractions, including straight-run gasoline fractions. These gasolines are of limited use as motor fuels, as they contain large amounts of unsaturated hydrocarbons and do not meet the requirements of technical regulations of the Customs Union TR CU 013/2011 for grade 5 gasolines. Efficient use of pyrolysis gasolines, oligomer-gasolines and their mixtures with hydrocarbon fractions of various origin is complicated due to the presence of rapidly resinifying unsaturated (styrene, phenylacetylene, etc.), and diene hydrocarbons. Resins formed in such gasolines equally prevent both extraction of aromatic components, and their use as components of high octane fuels.

Despite the fact that the proposed group of inventions has been described in detail in the exemplary embodiments that appear to be preferable, it should be remembered that these embodiments are given to illustrate the group of invention only. This description should not be construed as limiting the scope of the group of inventions, because the experts in the field of oil, petrochemicals, physics, etc. may introduce changes in the steps of the described methods and the catalyst, which are aimed at adapting them to specific devices or situations, and which do not go beyond the scope of the attached claims of the group of inventions. One skilled in the art will appreciate that within the scope of application of the group of inventions, which is defined by the claims, various options and modifications, including equivalent solutions, are possible.

1-6. (canceled)

7. A method of converting hydrocarbon fractions and oxygenates into a product, the method comprising:
a. reacting a hydrocarbon feedstock and a water oxygenate mixture in the presence of a catalyst to form a conversion product;
b. the catalyst comprises HZSM-5 zeolite, a binder; wherein the catalyst has been treated: with steam; and, a temperature of 450-500° C.; and,
c. the water oxygenate mixture comprises 10% to 50% water;
d. conducting reaction at a pressure from 1 to 50 bar, and at a reaction temperature of 290-460° C.;
e. thereby producing the conversion product.

8. The method of claim 7, wherein the steam treatment comprises steam treating a binder.

9. The method of claim 8, wherein the binder comprises sodium silicate and aluminum oxide.

10. The method of claim 7, wherein the binder comprises pseudoboehmite.

11. The method of claim 7, wherein the binder comprises a mixture of pseudoboehmite and silica glass.

12. The method of claim 7, wherein the hydrocarbon feedstock comprises pyrolysis hydrocarbon fractions.

13. The method of claim 7, wherein the hydrocarbon feedstock comprises oligomer hydrocarbon fractions.

14. The method of claim 7, wherein the hydrocarbon feedstock comprises light fractions of catalytic cracking gasolines.

15. The method of claim 7, wherein the hydrocarbon feedstock comprises a mixture of hydrocarbon fractions, including those containing up to 85 wt. % of olefins,

16. The method of claim 7, wherein the hydrocarbon feedstock comprises hydrocarbon fractions selected from the group consisting of pyrolysis gasolines, oligomer gasolines, light fractions of catalytic cracking gasolines having a final boiling point of up to 150° C., straight-run hydrocarbon fractions containing components with boiling points in the range of 25-200° C., and fractions containing C₂-C₁₄ olefins.

17. The method of claim 7, wherein the oxygenate water mixture comprises up to 70% methanol.

18. The method of claim 7, wherein the oxygenate water mixture comprises up to 60% ethanol.

19. The method of claim 7, wherein the oxygenate water mixture comprises an oxygenate selected from the group consisting of methanol and ethanol.

20. The method of claim 7, wherein the conversion product comprises high octane components for use in formulating high octane gasolines.

21. The method of claim 7, wherein the conversion product comprises aromatic hydrocarbons.

22. The method of claim 7, wherein the hydrocarbon feedstock and water oxygenate mixture is feed to the reaction at a mass feed rate of 0.5-4 h⁻¹.

23. The method of claim 7, wherein the reaction temperature is 365-420° C.

24. The method of claim 7, wherein the pressure is 1 to 5 bar.

25. The method of claim 7, wherein the pressure is 3 bar.

26. The method of claim 7, wherein the catalyst further comprises a mixture of pentasil group zeolites having silicate moduluses, wherein the silicate moduluses comprises a zeolite having SiO₂/Al₂O₃=15-30, previously treated with an aqueous alkaline solution and modified with oxides of rare earth elements in an amount of 0.5-2.0 wt. %, and the zeolite having SiO₂/Al₂O₃=50-85 with a residual amount of sodium oxide of 0.04-0.15 wt. % taken in a ratio of 1.7/1 to 2.8/1.

27. The method of claim 7, wherein a sulfur content of the hydrocarbon feedstock is reduced.

28. The method of claim 7, wherein a sulfur content of the hydrocarbon feedstock is reduced; whereby the reduction comprises a 84% reduction.

29. The method of claim 7, wherein the hydrocarbon feedstock and water oxygenate mixture are feed to the reaction in a ratio, whereby water is supplied to the reaction at a volume ratio of water:hydrocarbon=1:10-50.

30. A method of converting hydrocarbon fractions and oxygenates into a product, the method comprising:
a. reacting a hydrocarbon feedstock and a water oxygenate mixture in the presence of a catalyst to form a conversion product;
b. the catalyst comprises HZSM-5 zeolite, a binder, wherein the catalyst has been treated with steam;
c. the water oxygenate mixture comprises up to 50% water; wherein during the reaction the amount of water is increased; and,
d. conducting the reaction at a pressure from 1 to 50 bar;
e. thereby producing the conversion product.

31. The method of claim 30, wherein the steam treatment comprises steam treating a binder.

32. The method of claim 31, wherein the binder comprises sodium silicate and aluminum oxide.

33. The method of claim 30, wherein the binder comprises pseudoboehmite.

34. The method of claim 30, wherein the binder comprises a mixture of pseudoboehmite and silica glass.

35. The method of claim 30, wherein the hydrocarbon feedstock comprises pyrolysis hydrocarbon fractions.

36. The method of claim 30, wherein the hydrocarbon feedstock comprises a mixture of hydrocarbon fractions, including those containing up to 85 wt. % of olefins,

37. The method of claim 30, wherein the hydrocarbon feedstock comprises hydrocarbon fractions selected from the group consisting of pyrolysis gasolines, oligomer gasolines, light fractions of catalytic cracking gasolines having a final boiling point of up to 150° C., straight-run hydrocarbon fractions containing components with boiling points in the range 25-200° C., and fractions containing C₂-C₁₄ olefins.

38. The method of claim 30, wherein the oxygenate water mixture comprises an oxygenate selected from the group consisting of methanol and ethanol.

39. The method of claim 30, wherein the conversion product comprises high octane components for use in formulating high octane gasolines.

40. The method of claim 30, wherein the conversion product comprises aromatic hydrocarbons.

41. The method of claim 30, wherein the reaction is conducted at a temperature of 290-460° C.; and wherein the hydrocarbon feedstock and water oxygenate mixture is feed to the reaction at a mass feed rate of 0.5-4 h⁻¹.

42. The method of claim 30, wherein the reaction is conducted at a temperature of 365-420° C. and at a pressure of 1 to 5 bar.

43. The method of claim 30, wherein the reaction is conducted at a temperature of 290-460° C.

44. The method of claim 30, wherein a sulfur content of the hydrocarbon feedstock is reduced.

45. The method of claim 30, wherein the hydrocarbon feedstock and water oxygenate mixture are feed to the reaction in a ratio, whereby water is supplied to the reaction at a volume ratio of water:hydrocarbon=1:10-50.

46. The method of claim 30, wherein the catalyst has been treated with a temperature of 450-500° C.

47. A method of converting hydrocarbon fractions and oxygenates into a product, the method comprising:
a. reacting a hydrocarbon feedstock, the feedstock comprising sulfur defining a first sulfur content, and a water oxygenate mixture in the presence of a catalysis to form a conversion product;
b. the catalyst comprises HZSM-5 zeolite, wherein the catalyst has been treated: with steam; and, a temperature of 450-500° C.;
c. the water oxygenate mixture comprises water and an oxygenate selected from the group consisting of methanol and ethanol; and,
d. conducting the reaction at a temperature of 290-460° C.;
e. thereby producing a conversion product having a second sulfur content;
wherein the second sulfur content is lower than the first sulfur content.

48. The method of claim 47, wherein the steam treatment comprises steam treating a binder.

49. The method of claim 48, wherein the binder comprises sodium silicate and aluminum oxide.

50. The method of claim 47, wherein the binder comprises pseudoboehmite.

51. The method of claim 47, wherein the binder comprises a mixture of pseudoboehmite and silica glass.

52. The method of claim 47, wherein the hydrocarbon feedstock comprises light fractions of catalytic cracking gasolines.

53. The method of claim 47, wherein the hydrocarbon feedstock comprises a mixture of hydrocarbon fractions, including those containing up to 85 wt. % of olefins,

54. The method of claim 47, wherein the hydrocarbon feedstock comprises hydrocarbon fractions selected from the group consisting of pyrolysis gasolines, oligomer gasolines, light fractions of catalytic cracking gasolines having a final boiling point of up to 150° C., straight-run hydrocarbon fractions containing components with boiling points in the range of 25-200° C., and fractions containing C₂-C₁₄ olefins.

55. The method of claim 47, wherein the oxygenate water mixture comprises 70% methanol.

56. The method of claim 47, wherein the conversion product comprises high octane components for use in formulating high octane gasolines.

57. The method of claim 47, wherein the hydrocarbon feed stock and water oxygenate mixture is feed to the reaction at a mass feed rate of 0.5-4 h⁻¹.

58. The method of claim 47, wherein the reaction temperature is 365-420° C.

59. The method of claim 47, wherein the reaction is conducted at a pressure of 1 to 5 bar.

60. The method of claim 47, wherein the catalyst further comprises a mixture of pentasil group zeolites having silicate moduluses, wherein the silicate moduluses comprises a zeolite having SiO₂/Al₂O₃=15-30, previously treated with an aqueous alkaline solution and modified with oxides of rare earth elements in an amount of 0.5-2.0 wt. %, and the zeolite having SiO₂/Al₂O₃=50-85 with a residual amount of sodium oxide of 0.04-0.15 wt. % taken in a ratio of 1.7/1 to 2.8/1.

61. The method of claim 47, wherein the lower sulfur content comprises a 84% reduction in sulfur content.

62. The method of claim 47, wherein the hydrocarbon feedstock and water oxygenate mixture are feed to the reaction in a ratio, whereby water is supplied to the reaction at a volume ratio of water:hydrocarbon=1:10-50.

63. A catalyst for carrying out a method of co-converting hydrocarbon fractions and oxygenates into high octane components of fuels or aromatic hydrocarbons, the catalyst comprising: a HZSM-5 zeolite comprising a silicate modulus of SiO₂/Al₂O₃=50-81.9 with a residual amount of sodium oxide of 0.04-0.15 wt. % in an amount of 65-69.8 wt. %; zinc oxide in an amount of 1.5-2 wt. %; oxides of rare earth elements in an amount of 1-2 wt. %; oxides, sulfides or both of Group VIII metals in an amount of 0.5-1 wt. %; a binder having a balance of 100%, wherein the binder is a mixture of alumina in an amount of 30.1-69.9% by weight and silicon oxide in an amount of 69.9-30.1% by weight; and wherein the HZSM-5 zeolite has passed a thermal and steam treatment before a catalyst preparation step.
